(19) United States
(12) Patent Application Publication
(10) Pub. No.: US 2006/0251762 A1
(43) Pub. Date: Nov. 9, 2006

(54) Grain wet milling process for producing ethanol

(76) Inventors: Robert Jansen, Portela (PT); John Kerr, Surrey (GB); Edward Farley, Essex (GB); Gordon Walker, Oxfordshire (GB); Sebastien Camborieux, Middlesex (GB)

Correspondence Address: WILLIAMS, MORGAN & AMERSON, 10333 RICHMOND, SUITE 1100, HOUSTON, TX, 77042, US

(21) Appl. No.: 11/121,295

(22) Filed: May 3, 2005

(51) Int. Cl. A23L 1/10

(52) U.S. Cl. 426/28

(57) ABSTRACT

Whole grain, such as wheat, barley, rye, and/or rice, can be processed by (a) steeping the grain in an aqueous liquid to produce softened grain, (b) milling the softened grain to produce milled grain, (c) liquefying the milled grain by contacting it with amylase and heating it to a temperature of at least about 50° C., producing a liquefied material, (d) at least partially saccharifying the liquefied material by contacting it with amyloglucosidase at a temperature of at least about 50° C., producing a first saccharified material, and (e) separating fiber and germ from the first saccharified material, producing a screened material that is substantially free of fiber and germ. The process also includes the steps of (f) further saccharifying and fermenting the screened material with a microorganism that produces ethanol, thereby producing a broth that comprises ethanol, soluble protein, and insoluble protein, and (g) separating ethanol from the broth. A protein-rich product can be recovered from the broth that comprises both gluten from the grain and microorganism from the fermenting step.

### BACKGROUND OF THE INVENTION

Wheat comprises starch, germ, bran, and a protein known as gluten. It is desirable to separate the constituents of wheat into separate materials. Wheat can be processed by dry milling wheat grains to remove the bran and the germ, then milling the remainder of the grains to produce wheat flour. The wheat flour can be further processed in order to generate separate starch, protein, and/or other products. Processing of the flour often involves separating starch from gluten. These process steps are typically done at a relatively low temperature, for example about 30° C. The starch can optionally be hydrolyzed and saccharified to produce dextrose, or can be fermented after or with saccharification to produce ethanol. Often a lower grade starch that is difficult to purify is used to make ethanol. The gluten produced in conventional wheat processes is vital wheat gluten, which has visco-elastic properties that are valuable in some situations.

However, previously-known wheat processes have certain disadvantages. For example, the yields of starch, dextrose, and protein are not as high as might be desired. As one specific example, the yield of vital wheat gluten is relatively low (typically about 6.5 wt %). The bran, which typically makes up about 23% by weight of the wheat, is separated early in the process and takes with it a substantial amount of starch and protein. Because bran generally sells for a lower price than protein or dextrose, this problem has a negative effect on the economics of wheat processing.

Another problem with conventional wheat processes stems from the low temperatures used. At these temperatures, it is difficult to prevent the growth of microorganisms, which leads to unwanted fermentation, loss of yield and problems with product quality. In order to minimize this problem, chemicals to control micro-organisms such as sodium hypochlorite and chlorine dioxide are added. Caustic soda is often added to ensure that the pH does not drop too low due to the production of organic acids by the unwanted fermentation. The use of these chemicals can affect the functional visco-elastic properties of the vital wheat gluten, reducing its quality. An alternative to adding chemicals is to use more water rather than recycling, but this leads to extra energy costs to evaporate the water.

There is a need for a wheat process that reduces or eliminates one or more of the disadvantages of the prior processes.

### SUMMARY OF THE INVENTION

One aspect of the invention is a process that comprises (a) steeping at least one of wheat, barley, rye, or rice in an aqueous liquid to produce softened grain, (b) milling the softened grain to produce milled grain, (c) liquefying the milled grain by contacting it with amylase and heating it to a temperature of at least about 50° C., producing a liquefied material, (d) at least partially saccharifying the liquefied material by contacting it with amyloglucosidase at a temperature of at least about 50° C., producing a first saccharified material, and (e) separating fiber and germ from the first saccharified material, producing a screened material that is substantially free of fiber and germ. The process also includes the steps of (f) further saccharifying and fermenting the screened material with a microorganism that produces ethanol, thereby producing a broth that comprises ethanol and insoluble protein, and (g) separating ethanol from the broth. The insoluble protein, which comprises both protein from the feed grain and microorganism from the fermenting, can also be separated as a protein-rich product.

In one embodiment of the invention, before steeping the wheat, barley, rye, and/or rice, the grain can be at least partially dehulled by milling. This removes at least some of the bran from the grain. The partially dehulled grain can then be steeped and further processed as described above.

Another aspect of the invention is a non-binding, non-yellow protein composition that is produced by the process described above. The composition can comprise at least 60% by weight protein, and no more than about 1.5% by weight reducing sugars, both on a dry solids basis, and further contains no more than about 10% by weight moisture. Unlike vital wheat gluten, this composition is non-binding, and unlike corn gluten meal, it is not yellow. In some embodiments of the invention, the composition has a L* value of at least about 70, an a* value of no greater than about 5, and a b* value of no greater than about 20 on the Hunter color scale. In other embodiments, the composition has an a* value of no greater than about 3 and a b* value of no greater than about 15 on the Hunter color scale. The protein can comprise a mixture of wheat protein and yeast protein. In some embodiments of the invention, the yeast protein is about 5-30% by weight of the total protein in the composition. In some embodiments, the protein composition comprises at least about a 30% higher concentration of asparagine, alanine, and lysine on a dry solids basis than does vital wheat gluten.

One embodiment of the process comprises a dextrose-producing line of steps and an ethanol-producing line of steps. The dextrose-producing line of steps comprises:

(d-1) steeping at least one of wheat, barley, rye, or rice in an aqueous liquid to produce softened grain;

(d-2) milling the softened grain to produce milled grain;

(d-3) liquefying the milled grain by contacting it with amylase and heating it to a temperature of at least about 50° C., producing a liquefied material;

(d-4) at least partially saccharifying the liquefied material by contacting it with amyloglucosidase at a temperature of at least about 50° C., producing a first saccharified material;

(d-5) separating fiber and germ from the first saccharified material, producing a screened material that is substantially free of fiber and germ and a first fiber and germ stream;

(d-6) further saccharifying the screened material by contacting it with amyloglucosidase at a temperature of at least about 50° C., producing a second saccharified material;

(d-7) membrane filtering the second saccharified material, producing a permeate that comprises primarily dextrose and other soluble components and a retentate that comprises insoluble protein;

(d-8) purifying the permeate by chromatographic separation, producing a purified dextrose stream and a raffinate.

The ethanol-producing line of steps in this embodiment of the process comprises:

(e-1) steeping at least one of wheat, barley, rye, or rice in an aqueous liquid to produce softened grain;

(e-2) milling the softened grain to produce milled grain;

(e-3) liquefying the milled grain by contacting it with amylase and heating it to a temperature of at least about 50° C., producing a liquefied material;

(e-4) at least partially saccharifying the liquefied material by contacting it with amyloglucosidase at a temperature of at least about 50° C., producing a first saccharified material;

(e-5) combining the first fiber and germ stream from step (d-5) with the first saccharified material from step (e-4), and separating fiber and germ therefrom, producing a screened material that is substantially free of fiber and germ and a second fiber and germ stream;

(e-6) fermenting the screened material with a microorganism that produces ethanol, thereby producing a broth that comprises ethanol and insoluble protein; and

(e-7) separating ethanol from the broth.

The retentate from step (d-7) and the raffinate from step (d-8) can be added to the screened material from step (e-5) for fermenting in step (e-6).

### BRIEF DESCRIPTION OF THE DRAWINGS

FIG. 1 is a process flow diagram of an embodiment of the invention in which ethanol, gluten, and high-fiber animal feed products are produced from wheat.

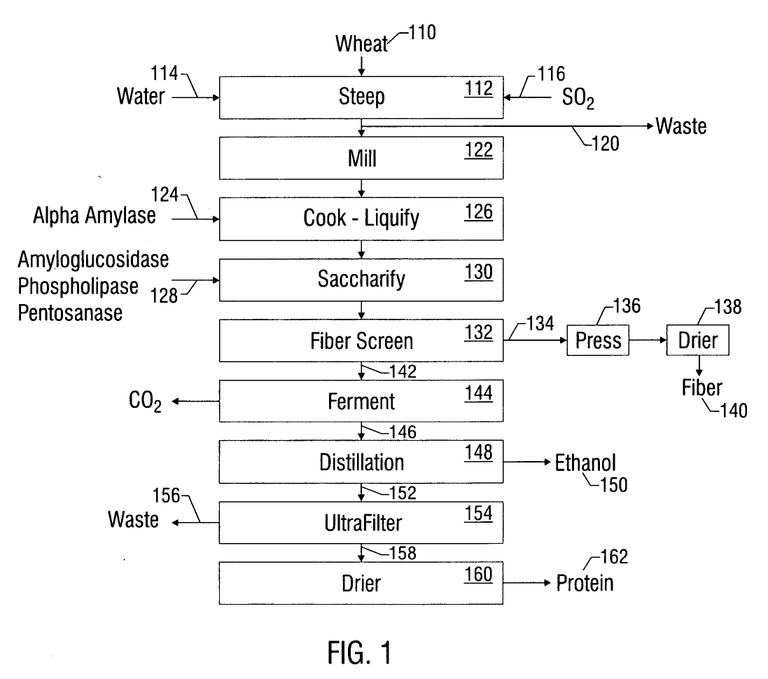

FIG. 2 is a process flow diagram of another embodiment of the invention in which dextrose, protein, and ethanol products are recovered.

### DESCRIPTION OF ILLUSTRATIVE EMBODIMENTS

One embodiment of the invention is a process that can produce ethanol, a high protein product, and a high fiber product from wheat. Other grains such as barley, rice, or rye can also be used, as well as combinations of two or more of these grains.

In one embodiment of the process, the feed grain can be at least partially dehulled by milling, for example in a Buhler mill or a Satake mill. This removes some of the bran in the feed grain, and tends to reduce the yield of starch and protein.

The process involves steeping wheat in an aqueous liquid to produce softened wheat. The wheat grains can be steeped, for example, in water or an aqueous solution to which SO₂ has been added.

The softened wheat, or softened partially dehulled wheat is then milled. The milled wheat is then liquefied by contacting it with amylase and heating it to a temperature of at least about 50° C., or in some cases, at least about 55° C. or at least about 70° C. This produces a liquefied material. The liquefied material is at least partially saccharified by contacting it with amyloglucosidase at a temperature of at least about 50° C., or in some case at least about 55° C. or at least about 70° C. This saccharification step results in a first saccharified material, which is then processed in a separation step. The separation, which can be performed, for example, by screening, separates fiber and wheat germ from the first saccharified material. The separated fiber and wheat germ are suitable for use as animal feed. The screened material that remains is substantially free of fiber and wheat germ (i.e., the combined concentration of fiber and germ in the screened material is no more than about 5% by weight, and in some embodiments is much less than 5%, for example 1% or less).

The screened material is fermented with a microorganism that produces ethanol, thereby producing a broth that comprises ethanol, soluble protein, and insoluble protein. The ethanol can then be separated from the broth and recovered.

Although the process conditions can vary, in one embodiment of the process, the following conditions are used. The aqueous liquid is maintained at a temperature of about 40-60° C. and pH of about 5-6 during steeping. The milled wheat is maintained at a temperature of about 80-120° C. for about 0.5-5.0 hours during liquefying. The liquefied material is cooled to about 55-65° C. prior to saccharifying, and the liquefied material is maintained at a temperature of about 55-68° C. and a pH of about 4-4.5 for about 2-15 hours during first saccharifying. The fermentation is done at a temperature of about 20-35° C. and a pH of about 3.5-4.5. As mentioned previously, SO₂ can be added to the aqueous liquid during steeping, and phospholipase and/or pentosanase can be used in the saccharifying step in addition to amyloglucosidase.

The process can further comprise separating the broth into an insoluble protein-rich stream and a liquid effluent stream. A protein-rich product can be recovered from the insoluble protein-rich stream. This protein-rich product comprises both protein (e.g., gluten) from the feed grain and microorganism (e.g., yeast) from the fermentation, and will be described further below. The liquid effluent stream can be recycled to the milling step or elsewhere in the process.

The following is a more detailed description of certain specific embodiments of the invention.

The feed material for the process is whole grain wheat cereal 110. The wheat is cleaned of straw and stones, usually by screening. The cleaned whole wheat is added to a steep tank 112, where it is soaked in water 114 to soften the grain. Sulfur dioxide 116 is also added to the steep tank. The steeping system can be either batch or continuous and the residence time of the wheat is about 16 hours. The temperature during the steep is 50° C.

The wheat is then separated from the steep water with a screen and a waste stream 120 can be withdrawn. The steeped wheat is milled 122, and this mill can be one or more of a variety of mills, but preferably is a toothed disc mill. The pH of the milled wheat slurry is adjusted to 5.6 and alpha amylase enzyme 124 is added to liquefy the starch content of the stream. The temperature is increased, for example to about 80-110° C., and the operation can be carried out in a starch cooker 126. The dry solids content of the liquefied material at this stage of the operation is about 15 to 20% d.s. The material is held for about 5 minutes, for example in a length of pipe sized for the purpose, to allow the liquefaction time to proceed. The slurry is then flashed to 98° C. and held for about 3 hours to allow liquefaction to complete.

The temperature of the liquefied material is then reduced to 62° C. and the pH adjusted to 4.2 and amyloglucosidase enzyme 128 is added. Phospholipase and pentosanase can be added at the same time. It is held for 2 to 12 hours to allow saccharification 130 to start and the viscosity to reduce. This partially-saccharified slurry is then screened 132 to remove fiber and germ. This can be done in a number of stages, using water to wash the sugars from the fiber in a counter-current manner. This water can be added in the final fiber screen, with the wash water then progressing to the first screen. Suitable types of screens include DSM screens and centrifugal screens.

The washed fiber and germ 134 can be pressed, for example in a screw press 136, and then dried 138, milled, and sold as an animal feed 140.

The screened material 142 from the fiber removal system 132 is placed in a fermenter 144 with a microorganism that can produce ethanol. Suitable microorganisms for this purpose include Saccharomyces cerevisiae, Saccharomyces carlsbergiensis, Kluyveromyces lactis, Kluyveromyces fragilis, and any other microorganism that makes ethanol and is acceptable as an animal feed. This includes genetically modified yeasts that are acceptable as animal feed. Further saccharification can also take place in the fermenter as a result of the presence of amyloglucosidase. As a result of the fermentation, most or all of the dextrose in the screened material 142 is converted, such that the resulting fermentation broth 146 comprises wheat protein, yeast, and ethanol. The ethanol 150 can be separated from the broth in a distillation unit 148. Suitable distillation temperatures can be about 60-110° C. Optionally, it can then be subjected to rectification and dehydration, to produce a fuel-grade ethanol product. Another option is to produce potable ethanol by rectification.

The material 152 remaining from the fermentation broth after separation of the ethanol can then be further purified by membrane filtration, for example in an ultrafiltration unit 154. The permeate 156 from this membrane filtration can be disposed of as a waste stream or recycled in the process. The retentate 158 from the membrane filtration, which comprises insoluble protein, optionally with some water added, is dried in a drier 160 to yield a protein-rich product 162. This protein-rich product is a combination of the wheat protein that was present in the feed 110 and the yeast or other microorganism used in the fermentation. Optionally, the protein-rich product can be combined with the fiber-germ material 140 for use as an animal feed.

The protein-rich product 162 will typically have low reducing sugar content (e.g., less than about 1.5% by weight) and color similar to conventional dried vital wheat gluten. The low content of reducing sugar makes the product easier to dry. High dextrose content in a protein product could cause charring or even fire during drying of the product. The yield of protein, in some embodiments of the process, can be considerably higher than in a conventional wheat process, for example as much as 13 wt % or even higher, as compared to about 6% in a conventional process. Although the gluten can be denatured by the heating in the process, the increased gluten yield can maintain the total value of the protein product as compared to that produced by a conventional wheat process.

After recovery and drying, the protein-rich product is a composition that comprises at least 60% by weight protein, no more than about 1.5% by weight reducing sugars (e.g., dextrose), and about 5% by weight moisture. Unlike vital wheat gluten, this composition is non-binding, and unlike corn gluten meal, it is not yellow. When measured on the Hunter scale the value of b*, where a higher value represents a more yellow color, is relatively low. The protein-rich product has a value typically less than half the value given by corn gluten meal, a value of b* of about 14 compared to 35.

The protein can comprise a mixture of wheat protein and yeast protein, and in one embodiment, the yeast protein is about 5-30% by weight of the total protein present in the composition. The yeast present in the protein-rich product can give this product increased values of the valuable amino acids asparagine, alanine and lysine, at least about 30% higher than in conventional wheat gluten. This product is suitable for a number of uses, among which are food for salmon, trout, and other fish.

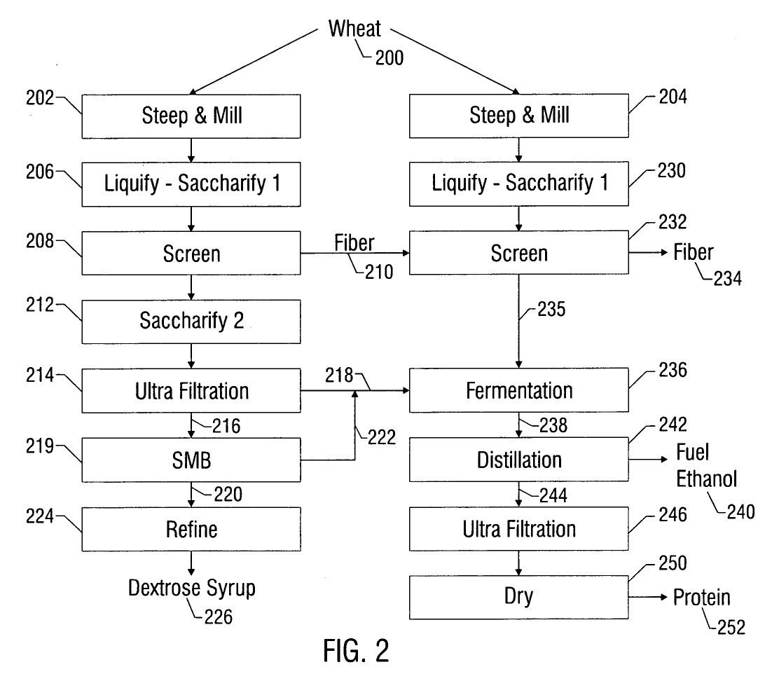

FIG. 2 shows another version of the process in which a dextrose product is produced, in addition to ethanol and protein products. Wheat 200 is cleaned by screening and added to two separate step tanks 202 and 204, in which it is steeped as described above. The wheat is then separated from the steep water in each of the two tanks with a screen and is milled. Alpha amylase is added to the milled wheat from steep tank 202 to liquefy 206 the starch content of the material. Temperature and pH are adjusted as described above, and amyloglucosidase is added to saccharify the material. This partially-saccharified slurry 208 is screened to remove fiber and germ 210. The slurry that passes through the screens is then contacted with additional amyloglucosidase for further saccharification 212. The saccharified material produced by this operation is then membrane filtered 214, for example by ultrafiltration, producing a permeate 216 and a retentate 218. The permeate 216 is purified by chromatographic separation 219 in a simulated moving bed unit, usually after pretreatment with carbon and/or softening, as described above. The chromatographic separation 219 yields a dextrose-rich stream 220 and a second 222 stream comprising maltose, oligosaccharides, ash, and soluble protein. The dextrose-rich stream 220 can be further refined 224 by carbon treatment and/or ion exchange, and then dried to produce a dextrose product 226, such as a dextrose syrup.

In the other branch of the process of FIG. 2, the milled wheat from steep tank 204 can be liquefied 230 with alpha amylase and saccharified with amyloglucosidase. The fiber and germ stream 210 from the screening step 208 can be combined with the partially saccharified slurry, which can then be screened 232 to separate the majority of the fiber and germ from the rest of the stream. The fiber and germ can be recovered as a product stream 234.

The screened, partially-saccharified material 235 from step 232, together with the retentate 218 from step 214 and the raffinate 222 from step 219 can then be subjected to fermentation 236 with a microorganism that can produce ethanol. Suitable microorganisms for this purpose include Saccharomyces cerevisiae, Saccharomyces carlsbergiensis, Kluyveromyces lactis, Kluyveromyces fragilis, and any other microorganism that makes ethanol and is acceptable as an animal feed. This includes genetically modified yeasts that are acceptable as animal feed. Further saccharification can also take place in the fermenter as a result of the presence of amyloglucosidase. As a result of the fermentation, most or all of the dextrose in the screened material 235 is converted, such that the resulting fermentation broth 238 comprises wheat protein, yeast, and ethanol. The ethanol 240 can be separated from the broth in a distillation unit 242. Optionally, it can then be subjected to rectification and dehydration, to produce a fuel-grade ethanol product. Another option is to produce potable ethanol by rectification.

The material 244 remaining from the fermentation broth after separation of the ethanol can then be further purified by membrane filtration 246, for example in an ultrafiltration unit. The permeate from this membrane filtration (not shown in FIG. 2) can be disposed of as a waste stream or recycled in the process. The retentate 248 from the membrane filtration, which comprises insoluble protein, optionally with some water added for diafiltration, is dried in a drier 250 to yield a protein-rich product 252. This protein-rich product is a combination of the wheat protein that was present in the feed 200 and the yeast or other microorganism used in the fermentation. Optionally, the protein-rich product can be combined with the fiber-germ material 234 for use as an animal feed. The protein-rich product 252 will typically have the properties described above, such as low reducing sugar content (e.g., less than about 1.5% by weight), non-binding, and non-yellow color.

One advantage of the embodiment shown in FIG. 2 is that the dextrose-rich stream (i.e., in the lower left side of the process flow diagram) can be kept at high purity, because impurities can be largely routed into the ethanol/protein branch of the process (i.e., the right side of the process flow diagram). This, plus the ability to produce a dextrose product in addition to an ethanol product, makes the process of FIG. 2 economically advantageous.

Various embodiments of the invention can be further understood from the following examples.

### EXAMPLE 1

A batch of whole wheat weighing 200 kg (dry solids (DS) 88.8%, protein 11.6% and ash 1.4%) was prepared by screening to remove stones and other unwanted material. This 200 kg of wheat was mixed with 550 liters of water in a 1 cu. meter tank. The mix was heated and kept at a temperature of 50° C. and sulphur dioxide was added as a 6% weight solution to a total of 1000 ppm. The pH of the mix was pH 6.1 and it was held for 18 hours.

At the end of this time the softened whole wheat was milled in a disc mill with toothed plates, with the complete batch being milled in 2 hours. To this whole batch of slurried wheat 94 g of an alpha-amylase enzyme, Liquozyme Supra, supplied by Novozyme, was added, and the batch was then jet cooked at 100° C. This took a total time of 1 hour. It was then held for a further 3 hours at 85° C. in the 1 cubic meter tank for liquefaction to complete.

The temperature of the liquefied mixture was reduced to 62° C., and the pH was reduced to pH 4.2 with dilute hydrochloric acid. Three enzymes were then added to the mix. These were 165 g of an amyloglucosidase enzyme, Dextrozyme DX, 155 g of a pentosanase enzyme, Shearzyme Plus, and 24 g of a phospholipase enzyme, Finizym W. All of these enzymes were supplied by Novozyme. The batch was then held for 4 hours to allow these enzymes to act.

The complete batch of material was then screened using a Sweco vibrating screen with a 100 micron mesh, the screening time being about 2 hours. This screening removed fiber from the slurry.

The remaining slurry was then divided into two batches. Batch 1 was 600 liters and batch 2 was 200 liters.

(a) Batch 1

The first batch of slurry produced by screening (Batch 1), with a volume of 600 liters was put into a 1 cubic meter fermentation tank. It was cooled to 30° C. and water was added to reduce the dry solids from 13% down to 9%, giving a total of about 900 liters. The fermentation was carried out by adding 225 g of Superstart yeast slurried in 1 liter of water. This yeast was Saccharomyces cerevisiae. Also added were 391 g of a 40% solution of urea as a nitrogen source.

The fermentation was allowed to continue for 48 hours, and the analysis of the product at the end of this fermentation is given in Table 1. At the end of this time ethanol was distilled from this fermented mixture in a QVF glass evaporator, operating at 60° C. and 200 mbar pressure. The ethanol content of the protein slurry was reduced to 0.25%, as shown in the analysis in Table 1 labeled “Feed to membrane.”

The slurry was then ultrafiltered on a ceramic ultrafilter having 2 square meters of membrane with a 0.05 micron pore size. This material was ultrafiltered until the retentate volume was 50 liters. Diafiltration was not carried out and the analysis of the permeate and the retentate are given in Table 1.

Tests were carried out to dry the filtered slurry on two different types of drier, a spray drier and a ring drier. These two driers were the same driers as tested to dry batch 1 and their descriptions are above.

The spray drying test used an atomizing pressure of 5 Barg. The inlet air temperature was 230° C. and the outlet temperature was 93° C. The dried material collected had 3.5% moisture and the bulk of the material was collected in the product container, with little material sticking to the walls of the drier.

It was concluded that the product made using this procedure dried well on this type of equipment.

The ring drier was tested by mixing some of the previously spray dried material with slurry to get a moisture content of 35.7% This moisture was judged to give a material that could be fed to the ring drier. The inlet air temperature of the drier was 250° C. and the outlet temperature was 95° C. The temperatures and the air flow to the drier were very steady and the product was collected from the product container. Its moisture content was 4.0% and analysis was as in Table 1.

It was concluded that this product dried well in a ring drier and that this type of drier could be used commercially for this product.

(b) Batch 2

Batch 2 was held in a tank for a further 36 hours at 62° C. to allow saccharification to complete. The batch, with an analysis as shown in Table 2, was then filtered using an ultrafilter having 2 square meters of filtration area. The ultrafilter membranes were ceramic units with a pore size of 0.05 micron. The temperature during this ultrafiltration was maintained at 62° C. and the total volume of retentate was reduced by a factor of 3 to give 67 liters. The analysis of the filtered permeate and the retentate is shown in Table 2.

The retentate was then diafiltered twice to remove dextrose. For the first diafiltration 50 liters of water was added and 50 liters of permeate were collected. This was repeated with the addition of 40 liters of water and the collection of 40 liters of permeate.

The resulting diafiltered retentate slurry contained protein and its analysis is shown in Table 2. Approximately 55 liters of this were collected and refrigerated prior to drying.

Two different driers were tested for this material. These were a spray drier and a ring drier.

The spray drier was a 1 meter diameter pilot unit. The nozzle used was a disc, a two fluid, flat spray type. The feed solids were measured at 12.5% ds and had a creamy color. The atomizing pressure was started at 4.0 Barg and then raised to 5.0 Barg after 15 minutes as no product was coming into the collecting chamber. The inlet temperature was kept at 250° C. and the outlet temperature maintained at 95° C. The plant was run for just over one hour and was stopped after 25 liters of material had been fed into the drier because no product had collected in the collecting chamber.

The drier was opened and the dried material was found to be stuck to the walls and ceiling of the drier chamber. This was scraped off and a total of 1.16 kg collected with a moisture content of 12.4%. Some of this material had charred, particularly the material stuck to the ceiling of the drying chamber.

It was concluded that spray drying could not be used commercially to dry a wheat protein product made using this procedure.

The second drier used was a pilot ring drier with a 3 inch ring with a classifier and a disintegrator. This type of drier cannot be fed with a slurry and in order to feed it some of the slurry was mixed with some of the dried powder produced by the spray drier. Portions of these were mixed together to give a feed material with a moisture content of 26.4%, which was judged to be a mixture suitable for feeding to the ring drier. This material was fed to the ring drier using an air inlet temperature of 250° C. The feed rate was maintained in an attempt to keep an outlet temperature of 95° C. The unit was unstable with the inlet air temperature changing, indicating that the air flow was not stable. Product was collected and the moisture content measured at 12.4% dry solids, and the analysis as in Table 2. On dismantling the drier it was found that material had stuck to the drier classifier, blocking the passage of air and preventing solids from recycling around the ring of the drier. The material was partially charred.

It was concluded that it would be difficult to dry material made using this procedure in a commercial ring drier because it tended to stick to the walls of the drier, particularly the classifying section, which is very important to the correct operation of this type of drier. The method used for Batch 1 where the fermentation removed virtually all of the dextrose, gave a superior product, and allowed drying to be carried out in commercial equipment.

TABLE 1
Batch 1

| | | Pro- | Glu- | Fruc- | Mal- | | Etha- |
|---|---|---|---|---|---|---|---|
| | DS | tein | cose | tose | tose | Ash | nol |
| After fermentation | 2.6 | 48.0 | 0.2 | 2.6 | 2.9 | — | 4.0 |
| Feed to membrane | 3.7 | 47.0 | 2.0 | 1.2 | — | 3.9 | 0.25 |
| Permeate | 1.7 | 38.2 | 5.2 | 3.0 | 8.8 | 19.1 | — |
| Retentate for drier | 14.9 | 59.9 | 0.9 | 0.4 | 0.9 | 3.7 | 0.25 |
| Dried product | 96.0 | 63.4 | 1.0 | 0.4 | — | 2.4 | — |

(All values are wt % on a dry solids basis.)

TABLE 2
Batch 2

| | | Pro- | Glu- | Fruc- | Mal- | |
|---|---|---|---|---|---|---|
| | DS | tein | cose | tose | tose | Ash |
| Feed to membrane | 17.2 | 10.4 | 72.7 | 1.2 | 2.4 | 1.5 |
| Permeate from membrane | 15.1 | 0.4 | 83.0 | 1.5 | 2.7 | 19.0 |
| Retentate from membrane | 19.6 | 25.7 | 57.6 | 1.2 | 2.0 | 1.6 |
| Retentate after | 12.0 | 33.9 | 47.3 | 0.8 | 1.6 | 2.6 |
| diafiltration | | | | | | |
| Dried product | 87.6 | 36.8 | 36.7 | 0.9 | 1.1 | 1.8 |

(All values are wt % on a dry solids basis.)

The color of the two protein products made in batches 1 and 2 was measured using the Hunter method. The values for the product made using the method in batches 1 and 2 are shown in Table 3, together with the Hunter values for conventional wheat gluten and conventional corn gluten meal.

TABLE 3
Hunter Measurement of Color

| Material | L* | a* | b* |
|---|---|---|---|
| Product - batch 1 | 75.3 | 2.0 | 14.4 |
| Product - batch 2 | 62.3 | 4.7 | 17.8 |
| Conventional Wheat Gluten | 84.7 | 1.2 | 13.7 |
| Conventional Corn Gluten | 71.0 | 10.2 | 35.8 |

The Hunter scale gives three measurement readings for color, L*, a* and b*:
L* is the degree of light and dark, a high value being white and a low value being black.
a* is the degree of redness, a high value being more red.
b* is the degree of yellowness, a high value being more yellow.

The results for batches 1 and 2 show that batch 2 is darker, with a lower L*. This is an indication of the degree of charring that occurred in the drier. The sample was noticeably darker when viewed by eye.

The results show that although the color of the protein made by this method is similar to conventional vital wheat gluten, when compared to corn gluten it has a much lower value for b*, showing it is much less yellow in color, and a lower value of a*, showing it is much less red in color.

The protein was analyzed for amino acid content and this analysis is shown in Table 4. In this table the protein produced by this method is compared with typical commercial wheat gluten made by conventional technology.

TABLE 4
Amino Acid Content of Protein

| | | % Amino Acid | |
|---|---|---|---|
| | % Amino Acid | Vital Wheat | |
| | Protein | Gluten | Relative % |
| Glutamine | 28.8% | 36.8% | 78.3% |
| Proline | 10.2% | 12.3% | 83.0% |
| Leucine | 8.7% | 7.4% | 118.2% |
| Phenylalanine | 6.0% | 5.5% | 108.6% |
| Serine | 4.8% | 5.3% | 91.1% |
| Valine | 5.3% | 4.1% | 127.8% |
| Asparagines | 4.6% | 2.9% | 160.9% |
| Arginine | 4.4% | 3.8% | 116.6% |
| Tyrosine | 3.5% | 3.5% | 100.1% |
| Isoleucine | 5.1% | 3.8% | 133.7% |
| Glycine | 3.6% | 3.3% | 108.7% |
| Alanine | 3.8% | 2.7% | 139.7% |
| Threonine | 3.4% | 2.8% | 121.0% |
| Histidine | 2.6% | 2.5% | 105.6% |
| Lysine | 3.1% | 1.5% | 197.1% |
| Methionine | 2.1% | 1.7% | 120.3% |
| | 100.0% | 100.0% | |

The table shows a significant increase in asparagine, alanine and lysine over conventional wheat gluten, due to the presence of yeast in the protein product.

### EXAMPLE 2

The material produced in Example 1 (a), batch 1, was found in the analysis to contain too much dextrose, leading to problems when drying this material. Laboratory tests were carried out in an attempt to reduce this dextrose level.

A sample of the retentate from batch 1, weighing 134.7 g was further dewatered on a 0.45 micron filter paper in a Buchner funnel in the laboratory. The analysis of feed, filtrate and the cake on the filter are shown in Table 3. The filtration on a 47 mm diameter filter was very slow, taking about 2 hours.

A portion of the cake after this filtration weighing 12.7 g was slurried with 12.8 g of distilled water to make the feed for a further filtration. This was also carried out on a 0.45 micron filter paper in a Buchner funnel. The analysis of the feed, the filtrate and the filtered cake are given in Table 5.

After these further two filtrations the protein cake still contained 5% dextrose on a dry solids basis.

These tests show that it is difficult to remove dextrose from the protein by washing with water, and a large amount of water would be required.

TABLE 5

| | | | | | Higher |
|---|---|---|---|---|---|
| | DS | Dextrose | Fructose | Maltose | sugars |
| Feed to | 12.6 | 43.2 | 0.9 | 1.5 | 1.0 |
| Filter 1 | | | | | |
| Filter 1 | 24.3 | 18.7 | 0.4 | 0.7 | 0.2 |
| Cake | | | | | |
| Filter 1 | 8.2 | 74.4 | 1.9 | 2.9 | 3.5 |
| Filtrate | | | | | |
| Feed to | 12.1 | 18.8 | 0.6 | 0.5 | 0.1 |
| Filter 2 | | | | | |
| Filter 2 | 33.8 | 5.0 | 0.1 | 0.1 | 0.0 |
| Cake | | | | | |
| Filter 2 | 4.1 | 71.8 | 1.8 | 2.5 | 2.3 |
| Filtrate | | | | | |

(All values are wt % on a dry solids basis.)

### EXAMPLE 3

A) Whole wheat was processed continuously in a pilot plant. The whole wheat used in this pilot plant was first screened to remove straw and stones. It was fed at a rate of 400 kg/hr into the top of a steep tank. This tank was vertical with a conical bottom and a volume of 20 m³. Water was fed into the steep tank from the bottom to flow counter-current to the wheat, which flowed down and exited the tank from the bottom of the cone. Into the water was added 1000 ppm of SO₂. The steep was operated in a continuous manner.

The residence time of the wheat in the steep tank was 16 hours, the temperature was 48° C. and the water flow was 800 liters/hour. The wheat exiting from the steep tank was first screened on a 1000 micron DSM screen to separate the wheat from water. It was then milled in mill which has a rotating toothed disc. The steep water was sent to waste

The milled wheat in a water slurry was then held in a small buffer tank. The pH of the slurry was adjusted to pH 5.6 using caustic soda. Amylase enzyme, Liquozyme Supra produced by Novozyme, was added at a rate of 0.4 kg/hr at this point. It was pumped from this tank at a flow of 1.5 m³/hour to a jet cooker. This cooker was supplied with steam and the temperature of the mix was controlled at 110° C. After the jet cooker the mix was held for 5 minutes in a length of pipe to allow liquefaction of the starch to proceed before the pressure was released by passing through a valve allowing the mix to pass into a flash vessel at atmospheric pressure, where the temperature dropped to 98° C.

The slurry was then held in tanks for 3 hours at 98° C. to allow liquefaction to complete. The pH was readjusted to pH 5.6 using sulphuric acid and a further 0.8 kg/hour of Liquozyme Supra was added. It was then pumped to a further flash vessel at 300 mbar where the temperature dropped to 62° C. The pH was reduced to pH 4.2 and an amyloglucosidase enzyme, Dextrozyme DX supplied by Novozyme was added at a rate of 1.08 kg/hour. Also added at this point were two other enzymes, a phospholipase enzyme called Finizym W, supplied by Novozymes, was added at 0.12 kg/hour, and a pentosanase, Shearzyme Plus, supplied by Novozyme was added at 0.8 kg/hour The material was held for 8 hours in a tank to allow saccharification to proceed to thin the mixture. At this stage the material had only been partially saccharified in this first stage saccharification tank. This allows the viscosity to be low enough to allow the fiber to be removed by screening. The screens used were four DSM type screens and one Centrisieve. The fibers were removed from the mixture and washed with water using a counter-current arrangement. The material from the first stage saccharification tank was fed to the first DSM screen which has a 50 micron screen. The fiber from this screen passes to the second, third and fourth screens being washed in a counter-current manner. These all had 75 micron screens. The fifth screen was a centrifugal sieve made by Larsson of Sweden. It was fitted with a 200 micron screen and fresh water was used on this screen for washing. This fiber was collected and used as animal feed. Its composition is given in Table 6. The screening system was operated in a continuous manner.

The de-fibred liquid from screen 1 was sent to a second stage of saccharification where it was held in four 12 m³ tanks, giving a total residence time of 24 hours.

TABLE 6

| | | | | Pro- | | Dex- | Fruc- |
|---|---|---|---|---|---|---|---|
| | DS | Starch | Fiber | tein | Fat | trose | tose |
| Wheat | 86.6 | 68.9 | 1.7 | 12.3 | 2.5 | — | — |
| Sacchari- | 16.0 | — | 0.4 | 14.3 | 1.7 | 70.7 | 0.8 |
| fication 2 | | | | | | | |
| Product | | | | | | | |

(All values are wt % on a dry solids basis.)

B) A 1 liter sample of the product from the second saccharification stage produced in example 3 was taken in order to carry out a laboratory fermentation test. This was mixed with 1 liter of distilled water and transferred to a 2 liter stirred flask. To this were added 11.4 g of urea peroxide and 20 g of bakers yeast (saccharomyces cerevisiae).

The temperature of the contents was adjusted to between 28 and 30° C. and the contents stirred and allowed to ferment. Samples were taken at regular intervals and the ethanol and dextrose contents measured using HPLC. After 43.5 hours the contents of the flask were centrifuged. The solids component weighed 126.4 g. These solids were 15 dried overnight in a vacuum oven and the protein content measured at 66% protein on a dried solids basis.

The analytical results are shown in Table 7.

TABLE 7

| Time (hrs) ) | Dry Solids % | Glucose | Maltose | Ethanol |
|---|---|---|---|---|
| 0 | 8.09 | 75.98 | 1.02 | 0 |
| 1 | 8.46 | 72.65 | 1.07 | 0 |
| 3 | 8.60 | 71.97 | 0.92 | 0 |
| 6 | 8.07 | 69.84 | 0.94 | 2.23 |
| 18 | 3.38 | 20.81 | 2.20 | 64.30 |
| 19.5 | 3.63 | 7.16 | 2.38 | 76.43 |
| 21.5 | 3.08 | 0.38 | 6.61 | 88.51 |
| 23.5 | 2.92 | 0.27 | 7.05 | 93.97 |
| 25.5 | 2.88 | 0.29 | 2.02 | 94.27 |
| 29.5 | 2.82 | 0.39 | 2.22 | 98.67 |
| 41.5 | 2.56 | 0.43 | 2.36 | 98.67 |
| 43.5 | 2.80 | 0.27 | 2.01 | 98.75 |

(All values are wt % on a dry solids basis.)

The preceding description is not intended to be an exhaustive list of every possible embodiment of the present invention. Persons skilled in the art will recognize that modifications could be made to the embodiments described above which would remain within the scope of the following claims.

We claim:

1. A process comprising:
(a) steeping at least one of wheat, barley, rye, or rice in an aqueous liquid to produce softened grain;
(b) milling the softened grain to produce milled grain;
(c) liquefying the milled grain by contacting it with amylase and heating it to a temperature of at least about 50° C., producing a liquefied material;
(d) at least partially saccharifying the liquefied material by contacting it with amyloglucosidase at a temperature of at least about 50° C., producing a first saccharified material;
(e) separating fiber and germ from the first saccharified material, producing a screened material that is substantially free of fiber and germ;
(f) further saccharifying and fermenting the screened material with a microorganism that produces ethanol, thereby producing a broth that comprises ethanol and insoluble protein; and
(g) separating ethanol from the broth.

2. The process of claim 1, further comprising at least partially dehulling the at least one of wheat, barley, rye, or rice prior to steeping.

3. The process of claim 1, wherein the insoluble protein comprises gluten from the grain and microorganism from the fermenting.

4. The process of claim 1, further comprising:
separating from the broth an insoluble protein-rich stream; and
recovering a protein-rich product that has a reducing sugar content of no more than about 1.5 wt %.

5. The process of claim 4, wherein the protein-rich product has a b* color value of no greater than about 20 on the Hunter scale.

6. The process of claim 5, wherein the protein-rich product has a b* color value on the Hunter scale of no greater than about 15

7. The process of claim 1, wherein the fermentation is done at a temperature of about 20-35° C. and a pH of about 3.5-4.5.

8. The process of claim 1, wherein during the saccharifying step the material is also contacted with at least one of phospholipase and pentosanase.

9. The process of claim 1, further comprising adding S0₂ to the aqueous liquid during steeping.

10. The process of claim 1, wherein:
the aqueous liquid is maintained at a temperature of about 40-60° C. and pH of about 5-6 during steeping;
the milled grain is maintained at a temperature of about 80-120° C. for about 0.5-5.0 hours during liquefying;
the liquefied material is cooled to about 55-65° C. prior to saccharifying; and
the liquefied material is maintained at a temperature of about 55-68° C. and a pH of about 4-4.5 for about 2-15 hours during saccharifying.

11. The process of claim 1, wherein ethanol is separated from the broth by distillation at about 60-65° C.

12. The process of claim 1, further comprising:
further saccharifying screened material by contacting it with amyloglucosidase at temperature of at least about 50° C., producing a second saccharified material;
membrane filtering the second saccharified material, producing a permeate that comprises primarily dextrose and other soluble components and a retentate that comprises insoluble protein; and
purifying the permeate by chromatographic separation, producing a purified dextrose stream.

13. A non-binding, non-yellow protein composition comprising no more than about 10 wt % moisture that is produced by the process of claim 4.

14. The composition of claim 13, wherein the protein in the composition comprises a mixture of wheat protein and yeast protein.

15. The composition of claim 14, wherein the yeast protein is about 5-30% by weight of the total protein in the composition.

16. The composition of claim 13, wherein the composition has a L* value of at least about 70, an a* value of no greater than about 5, and a b* value of no greater than about 20 on the Hunter color scale.

17. The composition of claim 16, wherein the composition has an a* value of no greater than about 3 and a b* value of no greater than about 15 on the Hunter color scale.

18. The composition of claim 16, wherein the composition comprises at least about 60 wt % protein on a dry solids basis.

19. The composition of claim 13, wherein the composition comprises at least about a 30% higher concentration of asparagine, alanine, and lysine on a dry solids basis than vital wheat gluten.

20. A process comprising a dextrose-producing line of steps and an ethanol-producing line of steps, wherein the dextrose-producing line of steps comprises:
(d-1) steeping at least one of wheat, barley, rye, or rice in an aqueous liquid to produce softened grain;
(d-2) milling the softened grain to produce milled grain;
(d-3) liquefying the milled grain by contacting it with amylase and heating it to a temperature of at least about 50° C., producing a liquefied material;
(d-4) at least partially saccharifying the liquefied material by contacting it with amyloglucosidase at a temperature of at least about 50° C., producing a first saccharified material;
(d-5) separating fiber and germ from the first saccharified material, producing a screened material that is substantially free of fiber and germ and a first fiber and germ stream;
(d-6) further saccharifying the screened material by contacting it with amyloglucosidase at a temperature of at least about 50° C., producing a second saccharified material;
(d-7) membrane filtering the second saccharified material, producing a permeate that comprises primarily dextrose and other soluble components and a retentate that comprises insoluble protein;
(d-8) purifying the permeate by chromatographic separation, producing a purified dextrose stream and a raffinate;
and wherein the ethanol-producing line of steps comprises:
(e-1) steeping at least one of wheat, barley, rye, or rice in an aqueous liquid to produce softened grain;
(e-2) milling the softened grain to produce milled grain;
(e-3) liquefying the milled grain by contacting it with amylase and heating it to a temperature of at least about 50° C., producing a liquefied material;
(e-4) at least partially saccharifying the liquefied material by contacting it with amyloglucosidase at a temperature of at least about 50° C., producing a first saccharified material;
(e-5) combining the first fiber and germ stream from step (d-5) with the first saccharified material from step (e-4), and separating fiber and germ therefrom, producing a screened material that is substantially free of fiber and germ and a second fiber and germ stream;
(e-6) fermenting the screened material with a microorganism that produces ethanol, thereby producing a broth that comprises ethanol and insoluble protein; and
(e-7) separating ethanol from the broth.

21. The process of claim 20, wherein the retentate from step (d-7) and the raffinate from step (d-8) are added to the screened material from step (e-5) for fermenting in step (e-6).

22. The process of claim 20, further comprising at least partially dehulling the at least one of wheat, barley, rye, or rice prior to steeping in steps (d-1) and (e-1).

23. The process of claim 20, wherein the insoluble protein in step (e-6) comprises gluten from the grain and microorganism from the fermenting.

24. The process of claim 20, further comprising:
separating from the broth an insoluble protein-rich stream; and
recovering a protein-rich product that has a reducing sugar content of no more than about 1.5 wt %.

25. The process of claim 24, wherein the protein-rich product has a b* color value of no greater than about 20 on the Hunter scale.

26. The process of claim 25, wherein the protein-rich product has a b* color value on the Hunter scale of no greater than about 15

27. The process of claim 20, wherein the fermentation is done at a temperature of about 20-35° C. and a pH of about 3.5-4.5.

28. The process of claim 20, wherein:
the aqueous liquid is maintained at a temperature of about 40-60° C. and pH of about 5-6 during steeping;
the milled grain is maintained at a temperature of about 80-120° C. for about 0.5-5.0 hours during liquefying;
the liquefied material is cooled to about 55-65° C. prior to saccharifying; and
the liquefied material is maintained at a temperature of about 55-68° C. and a pH of about 4-4.5 for about 2-15 hours during saccharifying.

29. The process of claim 20, wherein the chromatographic separation comprises simulated moving bed chromatography.
